(19) United States
(12) Patent Application Publication
(10) Pub. No.: US 2026/0126857 A1
(43) Pub. Date: May 7, 2026

(54) HAPTIC FEEDBACK METHOD AND APPARATUS BASED ON IMAGE TEXTURE, DEVICE, AND STORAGE MEDIUM

(71) Applicant: AAC Acoustic Technologies (Shanghai) Co., Ltd., Shanghai (CN)

(72) Inventors: Shiyu Pei, Shanghai (CN); Yajun Zheng, Shanghai (CN)

(21) Appl. No.: 19/174,961

(22) Filed: Apr. 10, 2025

Related U.S. Application Data
(63) Continuation of application No. PCT/CN2024/129960, filed on Nov. 5, 2024.

(51) Int. Cl. G06F 3/01; G06T 7/41

(52) U.S. Cl. CPC G06F 3/016; G06T 7/41

(57) ABSTRACT

A haptic feedback method and apparatus based on image texture, a device and a storage medium are provided. Object feature information of an image object is obtained according to a texture feature parameter of the image texture. A global relative vibration parameter corresponding to the image object is obtained according to the object feature information. On detecting a touch operation event relative to the image object, the local relative vibration parameter corresponding to a position at which the touch operation occurs is obtained according to the global relative vibration parameter. The actual vibration parameter of the haptic feedback actuator is mapped based on the local relative vibration parameter, and a vibration control signal corresponding to the position is generated according to the actual vibration parameter. The vibration control signal is sent to the executor, to control the executor to perform a vibration operation on the position.

### CROSS REFERENCE TO RELATED APPLICATIONS

The present application is a continuation of PCT Patent Application No. PCT/CN2024/129960, entitled “HAPTIC FEEDBACK METHOD AND APPARATUS BASED ON IMAGE TEXTURE, DEVICE, AND STORAGE MEDIUM,” filed Nov. 5, 2024, which is incorporated by reference herein in its entirety.

### TECHNICAL FIELD

This application relates to the technical field of electronics, and is appliable to haptic feedback scenarios of electronic devices. Specifically, this application relates to a haptic feedback method based on image texture, a haptic feedback apparatus based on image texture, a device, and a storage medium.

### BACKGROUND

With the continuous advancement of science and technology, electronic devices are becoming increasingly versatile. These devices now offer users a wide range of human-computer interaction functions. Among these, haptic feedback stands out as a key feature, significantly enhancing the user experience when operating electronic devices.

Currently, the haptic feedback technologies provided for electronic devices are limited to a few types: vibration feedback in response to a user's virtual keypress or specific in-game actions during gameplay. In other words, the diversity and interactivity of haptic feedback technologies in current solutions remain quite limited.

It is important to note that the technologies described in this section may not necessarily be those that have been previously envisioned or implemented. Unless explicitly stated otherwise, no assumption should be made that any technology mentioned here is considered prior art simply because it is included. Similarly, unless otherwise specified, the issues raised in this section should not be assumed to be universally recognized in existing technologies.

### SUMMARY

A haptic feedback method and apparatus based on image texture, a device and a storage medium are provided, aiming to solve at least one of the problems in the related technology to a certain extent.

To resolve the foregoing technical problem, a first aspect of this application provides a haptic feedback method based on image texture. The method includes: acquiring object feature information of an image object according to a texture feature parameter of an image texture in a target display image; acquiring, according to the object feature information, a global relative vibration parameter corresponding to the image object; on detecting a touch operation event relative to the image object, acquiring, according to the global relative vibration parameter, a local relative vibration parameter corresponding to a position at which a touch operation occurs; mapping an actual vibration parameter of a haptic feedback actuator based on the local relative vibration parameter, and generating, according to the actual vibration parameter, a vibration control signal corresponding to the position at which the touch operation occurs; and sending the vibration control signal to the haptic feedback executor to control the haptic feedback executor to perform a corresponding vibration operation on the position at which the touch operation occurs.

A second aspect of this application provides a haptic feedback apparatus based on image texture, including: an information acquisition module configured to acquire object feature information of an image object according to a texture feature parameter of an image texture in a target display image; a first parameter acquisition module configured to acquire, according to the object feature information, a global relative vibration parameter corresponding to the image object; a second parameter acquisition module configured to: on detecting a touch operation event relative to the image object, acquire, according to the global relative vibration parameter, a local relative vibration parameter corresponding to a position at which a touch operation occurs; a signal generation module configured to: map an actual vibration parameter of a haptic feedback actuator based on the local relative vibration parameter, and generate, according to the actual vibration parameter, a vibration control signal corresponding to the position at which the touch operation occurs; and a vibration control module configured to send the vibration control signal to the haptic feedback executor to control the haptic feedback executor to perform a corresponding vibration operation on the position at which the touch operation occurs.

A third aspect of this application provides an electronic device, including a memory and a processor. The processor is configured to execute a computer program stored in the memory to implement steps in the haptic feedback method based on image texture in the first aspect of this application.

A fourth aspect of this application provides a computer readable storage medium, where a computer program is stored in the computer readable storage medium, and the processor is configured to execute the computer program to implement steps in the haptic feedback method based on image texture in the first aspect of this application.

It can be learned from the foregoing that, according to the haptic feedback method and the haptic feedback apparatus based on image texture, the device and the storage medium in this application, object feature information of an image object is obtained according to a texture feature parameter of an image texture in a target display image. A global relative vibration parameter corresponding to the image object is obtained according to the object feature information. On detecting a touch operation event relative to the image object, the local relative vibration parameter corresponding to the position at which the touch operation occurs is obtained according to the global relative vibration parameter. The actual vibration parameter of the haptic feedback actuator is mapped based on the local relative vibration parameter, and a vibration control signal corresponding to the position at which the touch operation occurs is generated according to the actual vibration parameter. The vibration control signal is sent to the haptic feedback executor, to control the haptic feedback executor to perform a corresponding vibration operation on the position at which the touch operation occurs. Through the implementation of this application, a haptic feedback mechanism is provided for touch operations applied to image objects displayed on electronic devices. This mechanism can imitate the authenticity of the touch behavior on image objects, expand the application scope of haptic feedback, and enhance the interactivity and enjoyment of haptic feedback applications.

It should be understood that the content described in this section is neither intended to identify key or essential features of this application nor intended to limit the scope of this application. Other features of this application will become readily apparent through the following description.

### BRIEF DESCRIPTION OF THE DRAWINGS

The drawings illustratively show embodiments and form a part of the specification, and are used to explain exemplary implementations of the embodiments together with the textual description of the specification. The illustrated drawings are provided solely for exemplary purposes and do not limit the scope of the claims. Throughout the drawings, the same reference numerals refer to similar, but not necessarily identical, elements.

FIG. 1 illustrates a schematic flowchart of a haptic feedback method based on image texture according to an embodiment of this application.

FIG. 2 illustrates a schematic diagram of pixel-level relative vibration intensity according to an embodiment of this application.

FIG. 3 illustrates a schematic diagram of pixel-level relative vibration frequency according to an embodiment of this application.

FIG. 4 illustrates a schematic diagram of a touch operation event according to an embodiment of this application.

FIG. 5 illustrates a schematic diagram of a vibration envelope of a haptic feedback actuator according to an embodiment of this application.

FIG. 6 illustrates a schematic flowchart of the haptic feedback method based on image texture in detail according to an embodiment of this application.

FIG. 7 illustrates a schematic diagram of functional modules of the haptic feedback apparatus based on image texture according to an embodiment of this application.

FIG. 8 illustrates a schematic diagram of hardware structure of the electronic device according to an embodiment of this application.

### DETAILED DESCRIPTION OF THE EMBODIMENTS

To make the objectives, features, and advantages of the invention in this application more apparent and easier to understand, the technical solutions in the embodiments of this application will be clearly and comprehensively described below in conjunction with the accompanying drawings. It is evident that the described embodiments are merely a part not all of the embodiments of this application and. Based on the embodiments disclosed in this application, all other embodiments obtained by those skilled in the art without involving inventive effort fall within the scope of protection of this application.

In the description of the embodiments of this application, the terms “first” and “second” are used solely for descriptive purposes and should not be understood as indicating or implying relative importance, or implicitly specifying the number of technical features indicated. Thus, features defined with “first” or “second” may explicitly or implicitly include one or more of such features. The term “plurality” means two or more, unless otherwise specifically defined. The term “comprises” indicates the presence of the described features, whole, steps, operations, elements, and/or components, but does not exclude the presence or addition of one or more other features, wholes, steps, operations, elements, components, and/or their combinations. The term “and/or” describes the associative relationship between related objects, indicating that three relationships may exist: A and/or B may include A alone, A and B together, or B alone. The character “/” generally signifies a relationship where the objects on either side belong to an “or” relationship.

To solve the problem that the diversification and interactivity of haptic feedback technologies provided in the related art are still relatively limited, an embodiment of this application provides a haptic feedback method based on image texture. This method is appliable to electronic devices configured with haptic feedback actuators (e.g., smartphones, tablets), and is also appliable to human-computer interaction systems that include a first electronic device (e.g., smartphones, tablets) and a second electronic device (e.g., VR devices configured with haptic feedback actuators, finger-worn haptic feedback devices, etc.).

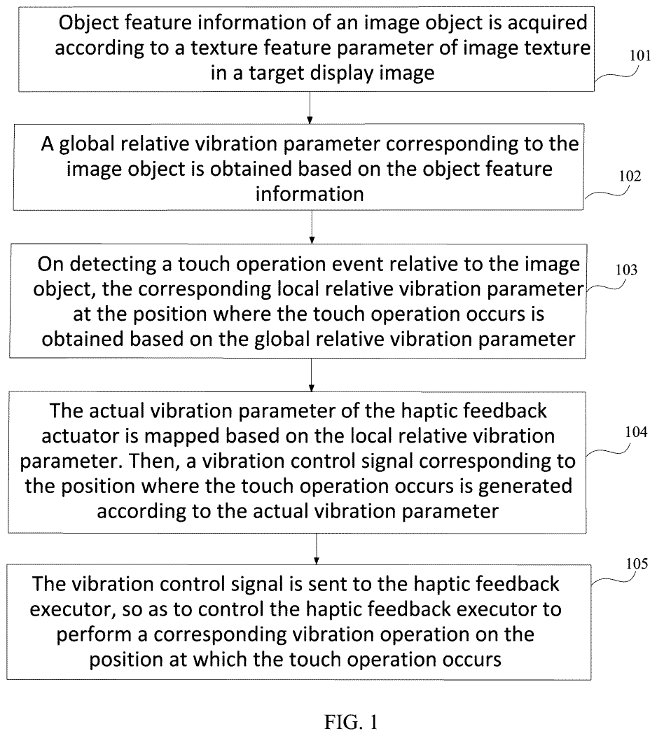

FIG. 1 illustrates a schematic flowchart of the haptic feedback method based on image texture according to the embodiment of this application. The method includes the following steps 101 to 105.

In step 101: object feature information of an image object is acquired according to a texture feature parameter of image texture in a target display image.

In practical applications, electronic devices can display images or videos (which include multiple frames). The image contains the imaging information of objects. In this embodiment, the object feature information includes the roughness and/or hardness of the image object. The image texture refers to the visual texture effect presented in the image, which typically includes the texture of the object's surface. It should be noted that in this embodiment, the raw input image or video may first undergo preprocessing to optimize the image or video quality and reduce the data volume, and then the target display image is obtained.

In an optional implementation of this embodiment, the object feature information is the roughness, and the target display image is first converted into a grayscale image. Then a first texture feature parameter of the grayscale image is extracted based on a grayscale co-occurrence matrix. Finally, the roughness of the image object is calculated based on a preset function between the first texture feature parameter and the roughness.

In this embodiment, the target display image is converted to the grayscale image, and image processing methods such as rotation, homomorphic filtering, or other techniques are applied to eliminate the impact of environmental factors (e.g., angle, lighting). The first texture feature parameter includes at least one of the following: texture entropy, texture inertia, texture contrast, texture correlation, or texture uniformity. Additionally, the function between the first texture feature parameter and roughness can be understood as a mapping relationship between different first texture feature parameters and roughness.

In an optional implementation of this embodiment, the object feature information is hardness, First, N displayed images that are in the currently displayed video and that are previous to the target display image are obtained. Then, the second texture feature information of the image texture in the target display image is collected according to the target display image and the N displayed images. Finally, the hardness of the image object is calculated based on a preset function between the second texture feature parameter and the hardness.

It should be noted that N is a positive integer greater than 0, and the second texture feature information includes deformation information.

In an optional implementation of this embodiment, the haptic feedback method further includes: querying a preset object prior information base for hardness corresponding to the image object, where the N displayed images in the video being currently displayed that are previous to the target display image are acquired on failure of the query.

In practical applications, hardness prior information of known objects, can be obtained in advance. Based on the correspondence between the object and its hardness prior information, an object prior information database can be established. In the haptic feedback application scenario of this embodiment, the object prior information database can be queried based on the image object. If the image object corresponds to a known object in the object prior information database, the hardness obtained from the database can be directly used as the hardness of the image object, efficiently providing the hardness of the image object. Conversely, if the image object is not covered by the object prior information database, the deformation of the object in the current frame of the displayed image is statistically analyzed to estimate the hardness of the image object by the previously described approach.

In Step 102, a global relative vibration parameter corresponding to the image object is obtained based on the object feature information.

When a user interacts with the image displayed on the device and touches an object in the image, the touch area is typically a localized region on the image object. To provide haptic feedback for the local region of the image object, this embodiment preemptively analyzes the global relative vibration parameters at the pixel level across the entire image object.

In an optional embodiment of this application, the specific implementation of obtaining the global relative vibration parameters corresponding to the image object based on the object feature information includes, but is not limited to, the following two aspects: first obtaining the global relative vibration intensity corresponding to the image object based on the roughness of the image object; and second obtaining the global relative vibration frequency corresponding to the image object based on the hardness of the image object.

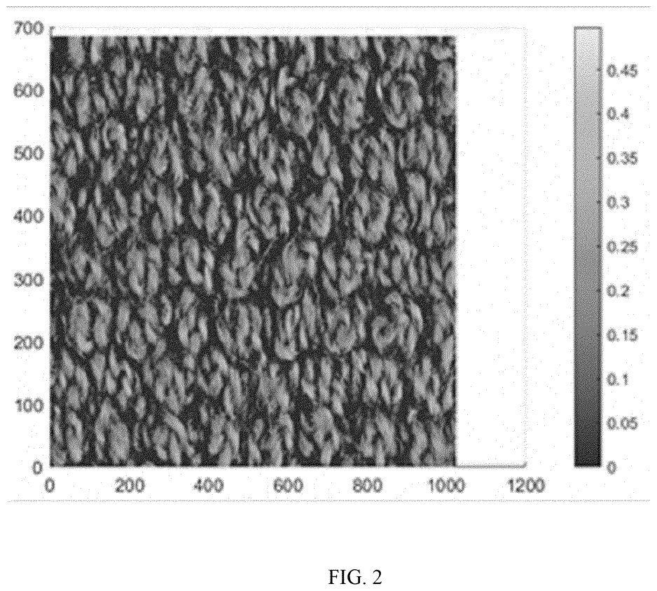

In this embodiment, the global relative vibration parameter corresponding to the image object can be obtained by mapping the roughness feature of the image object to the corresponding relative vibration intensity and the hardness of the image object to the corresponding relative vibration frequency. It should be noted that in this embodiment, a mapping function between roughness and relative vibration intensity is preconfigured. For the image object, this mapping function can be called to obtain the relative vibration intensity for each pixel based on its roughness. Then, the global relative vibration intensity of the image object can be obtained based on the relative vibration intensity of all pixels. FIG. 2 shows a schematic diagram of pixel-level relative vibration intensity according to an embodiment of this application, illustrating the mapping relationship between the roughness of the image object and the relative vibration intensity. In FIG. 2, the horizontal and vertical axes of the left coordinate system represent the x and y coordinates of the pixels, respectively, and the right bar chart represents the relative vibration intensity mapping based on color representation. By referring to the color of each pixel in FIG. 2, the corresponding relative vibration intensity can be mapped in the right bar chart. It should be noted that the foregoing mapping function may be represented as I=f₁ (R), and I∈[0, 1], where f₁( ) represents a mapping function from the roughness R to the relative vibration intensity I.

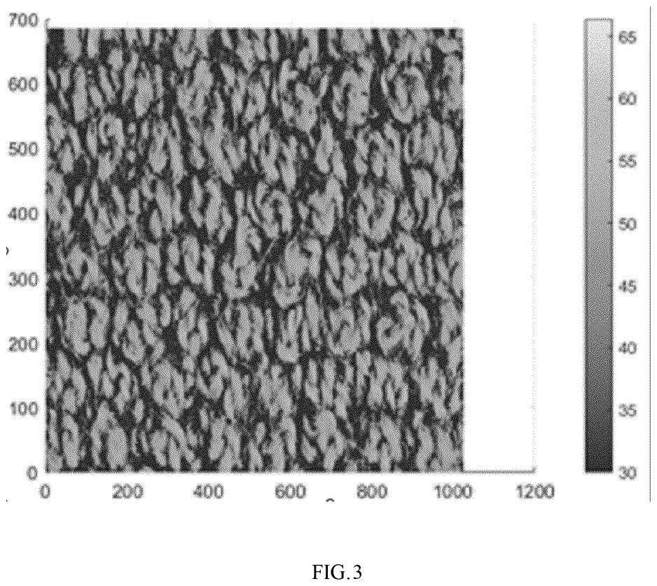

Additionally, this embodiment also pre-configures a mapping function between hardness and relative vibration frequency. Similarly, for the image object, the corresponding relative vibration frequency can be obtained for each pixel based on its hardness. Then, the global relative vibration frequency of the image object can be obtained based on the relative vibration frequencies of all pixels. FIG. 3 illustrates a schematic diagram of pixel-level relative vibration frequency according to an embodiment of this application, illustrating the mapping relationship between the hardness of the image object and the relative vibration frequency. In FIG. 3, the horizontal and vertical axes of the left coordinate system represent the x and y coordinates of the pixels, respectively, and the right bar chart represents the relative vibration frequency mapping based on color representation. By referring to the color of each pixel in FIG. 3, the corresponding relative vibration frequency can be mapped in the right bar chart. It should be noted that the foregoing mapping function may be represented as F=f₂(H), and F∈[0, 100], where f₂( ) represents a mapping function from the hardness H to the relative vibration frequency F.

In step 103, on detecting a touch operation event relative to the image object, the corresponding local relative vibration parameter at the position where the touch operation occurs is obtained based on the global relative vibration parameter.

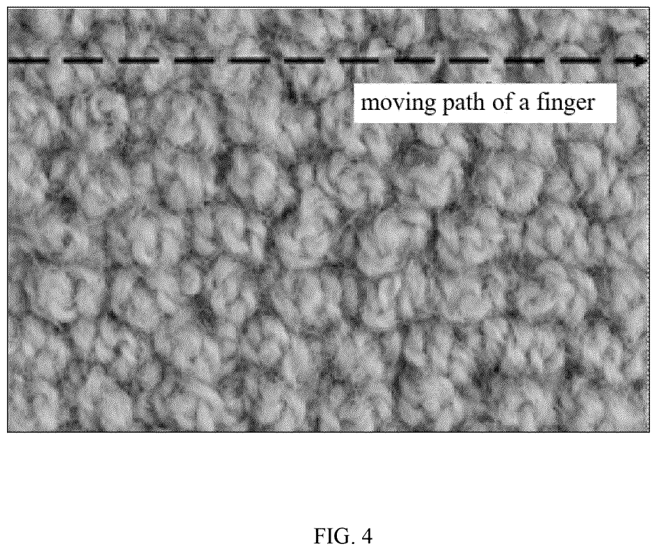

In practical applications, electronic devices display images on a touch screen. When a user performs a touch operation on an image object displayed on a touch screen that is capacitive, the electronic device can recognize the touch operation event based on the detected capacitance value. The recognized touch operation event includes, but is not limited to, the position at which the touch operation occurs, the pressure of the touch operation, and the speed of the touch operation. It should be noted that, in this embodiment, a touch operation speed is generally used for a sliding touch operation. When a user applies a sliding touch operation to an image, a finger has a moving path on the image. FIG. 4 presents a schematic diagram of a touch operation event according to an embodiment of this application, illustrating a moving path of a finger on an image. It should be further noted that, because a user performs a touch operation by touching a local area of an image object, and different areas of the object have different physical features, a human body has different haptic perception when touching different areas of the object. Therefore, in this embodiment, a corresponding local relative vibration parameter needs to be obtained according to the position at which the touch operation occurs.

In step 104, the actual vibration parameter of the haptic feedback actuator is mapped based on the local relative vibration parameter. Then, a vibration control signal corresponding to the position where the touch operation occurs is generated according to the actual vibration parameter.

The haptic feedback actuator in this embodiment can be understood as an actuator, which can specifically be a linear motor. The local relative vibration parameter which is obtained based on the image object is then mapped to the actuator-level parameter, i.e., the actual vibration parameter. Then, a vibration control signal, executable by the haptic feedback actuator, is generated based on the actual vibration parameters. It should be noted that, in practical applications, this embodiment can construct the aforementioned vibration control signal based on preset mathematical functions (such as sine, square wave, triangle wave, or polynomial functions).

In an optional implementation of this embodiment, the relative vibration parameter includes a relative vibration intensity and a relative vibration frequency. Correspondingly, the mapping, based on the local relative vibration parameter, the actual vibration parameter of the haptic feedback executor includes: weighting the local relative vibration intensity based on touch operation pressure, and weighting the local relative vibration frequency based on a touch operation speed; and mapping the weighted local relative vibration intensity to an actual vibration intensity of the haptic feedback actuator, and mapping the weighted local relative vibration frequency to an actual vibration frequency of the haptic feedback actuator.

In this embodiment, respective weighting functions are constructed for the relative vibration intensity and the relative vibration frequency. In basic implementation, both weighting functions are positive proportional functions. That is, higher touch operation pressure indicates higher relative vibration intensity, and a faster touch operation speed indicates a higher relative vibration frequency, so that a weighted local relative vibration parameter can enhance a perception capability of a user on vibration feedback.

In an optional implementation of this embodiment, the mapping the weighted local relative vibration intensity to an actual vibration intensity of the haptic feedback actuator and mapping the weighted local relative vibration frequency to an actual vibration frequency of the haptic feedback actuator includes: acquiring a rated voltage and a rated frequency response range of the haptic feedback actuator; mapping the weighted local relative vibration intensity to the actual vibration intensity of the haptic feedback actuator based on the rated voltage, and mapping the weighted local relative vibration frequency to the actual vibration frequency of the haptic feedback actuator based on the rated frequency response range.

In actual application, maximum intensity of the haptic feedback executor should not exceed a rated voltage of the haptic feedback executor and an actual frequency is within a rated frequency response range of the haptic feedback executor. Based on this, in this embodiment, a corresponding rated indicator (that is, the rated voltage and the rated frequency response range) may be determined according to a type of the haptic feedback executor. Then, the local relative vibration parameter is mapped to the actual vibration parameter (that is, the actual vibration intensity and the actual vibration frequency) of the haptic feedback executor.

In step 105, the vibration control signal is sent to the haptic feedback executor, so as to control the haptic feedback executor to perform a corresponding vibration operation on the position at which the touch operation occurs.

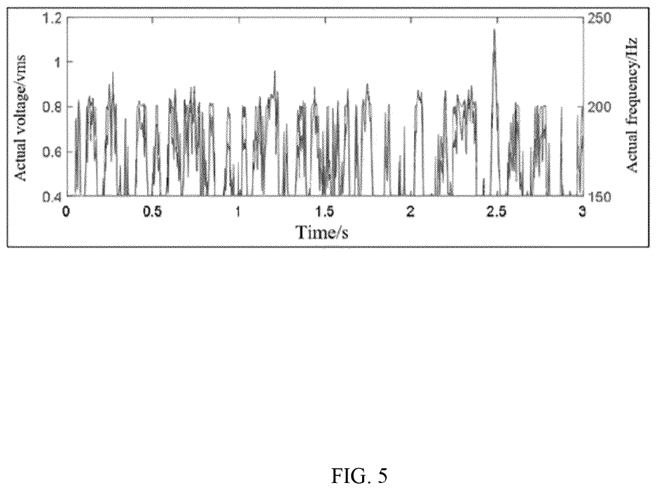

FIG. 5 illustrates a schematic diagram of a vibration envelope of a haptic feedback actuator according to an embodiment of this application. A corresponding touch operation event is that a finger moves for 3 seconds at a constant speed. In this embodiment, after a corresponding vibration control signal is generated for a position at which a touch operation occurs, the haptic feedback executor outputs, at the position at which the touch operation occurs, a vibration signal corresponding to a texture of an image object, to emulate haptic feeling of a user touching a real object, so as to help the user understand the object and improve interest of human-computer interaction.

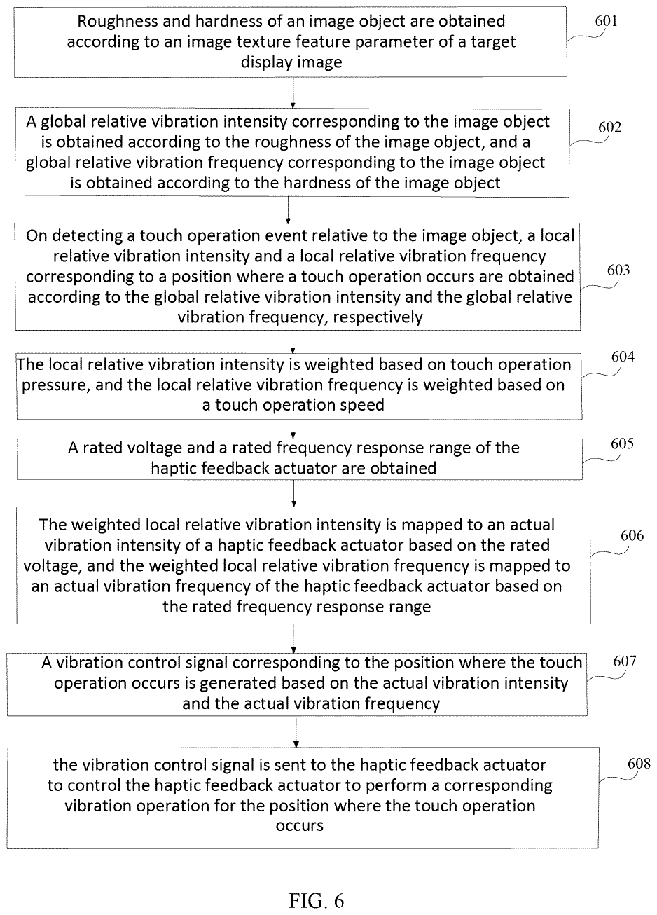

To better explain the embodiment of this application, the haptic feedback method based on image texture is described in detail below. FIG. 6 illustrates a schematic diagram of the haptic feedback method based on image texture in detail according to an embodiment of this application. Specifically, the haptic feedback method based on image texture includes the following steps 601 to 608.

In step 601, roughness and hardness of an image object are obtained according to an image texture feature parameter of a target display image.

In step 602, a global relative vibration intensity corresponding to the image object is obtained according to the roughness of the image object, and a global relative vibration frequency corresponding to the image object is obtained according to the hardness of the image object.

In step 603, on detecting a touch operation event relative to the image object, a local relative vibration intensity and a local relative vibration frequency corresponding to a position where a touch operation occurs are obtained according to the global relative vibration intensity and the global relative vibration frequency, respectively.

In step 604, the local relative vibration intensity is weighted based on touch operation pressure, and the local relative vibration frequency is weighted based on a touch operation speed.

In step 605, a rated voltage and a rated frequency response range of the haptic feedback actuator are obtained.

In step 606, the weighted local relative vibration intensity is mapped to an actual vibration intensity of a haptic feedback actuator based on the rated voltage, and the weighted local relative vibration frequency is mapped to an actual vibration frequency of the haptic feedback actuator based on the rated frequency response range.

In step 607, a vibration control signal corresponding to the position where the touch operation occurs is generated based on the actual vibration intensity and the actual vibration frequency.

In step 608, the vibration control signal is sent to the haptic feedback actuator to control the haptic feedback actuator to perform a corresponding vibration operation for the position where the touch operation occurs.

It should be understood that the numbering of steps in this embodiment does not imply the sequence in which the steps must be executed. The sequence in which the steps be executed should be determined based on functions and internal logic, and should not impose a strict limitation on the implementation process of the embodiment described in this application.

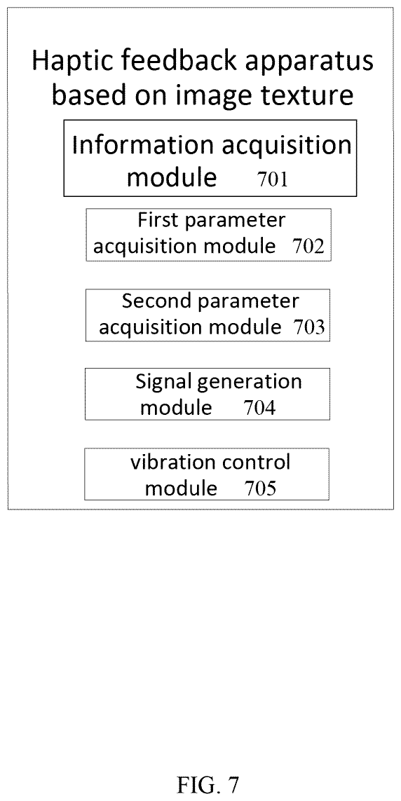

FIG. 7 illustrates a haptic feedback apparatus based on image texture according to an embodiment of this application. This haptic feedback apparatus is configured to implement the haptic feedback method described in the previous embodiments. The apparatus includes: an information acquisition module 701, a first parameter acquisition module 702, a second parameter acquisition module 703, a signal generation module 704, and a vibration control module 705.

The information acquisition module 701 is configured to acquire object feature information of an image object according to a texture feature parameter of an image texture in a target display image.

The first parameter acquisition module 702 is configured to acquire, according to the object feature information, a global relative vibration parameter corresponding to the image object.

The second parameter acquisition module 703 is configured to: on detecting a touch operation event relative to the image object, acquire, according to the global relative vibration parameter, a local relative vibration parameter corresponding to a position at which a touch operation occurs.

The signal generation module 704 is configured to: map an actual vibration parameter of a haptic feedback actuator based on the local relative vibration parameter, and generate, according to the actual vibration parameter, a vibration control signal corresponding to the position at which the touch operation occurs.

The vibration control module 705 is configured to send the vibration control signal to the haptic feedback executor to control the haptic feedback executor to perform a corresponding vibration operation on the position at which the touch operation occurs.

It should be noted that the haptic feedback method in the aforementioned method embodiments can all be implemented using the haptic feedback apparatus provided in this embodiment. Those skilled in the art can clearly understand that, for the sake of convenience and brevity in description, the specific working process of the haptic feedback apparatus described in this embodiment can refer to the corresponding working process in the aforementioned method embodiments, and thus will not be elaborated further here.

With the technical solution of the above embodiments of this application, the object feature information of the image object is obtained according to the texture feature parameter of the image texture in the target display image. A global relative vibration parameter corresponding to the image object is obtained according to the object feature information. On detecting a touch operation event relative to the image object, the local relative vibration parameter corresponding to the position at which the touch operation occurs is obtained according to the global relative vibration parameter. The actual vibration parameter of the haptic feedback actuator is mapped based on the local relative vibration parameter, and a vibration control signal corresponding to the position at which the touch operation occurs is generated according to the actual vibration parameter. The vibration control signal is sent to the haptic feedback executor, to control the haptic feedback executor to perform a corresponding vibration operation on the position at which the touch operation occurs. Through the implementation of this application, a haptic feedback mechanism is provided for touch operations applied to image objects displayed on electronic devices. This mechanism can imitate the authenticity of the touch behavior on image objects, expand the application scope of haptic feedback, and enhance the interactivity and enjoyment of haptic feedback applications.

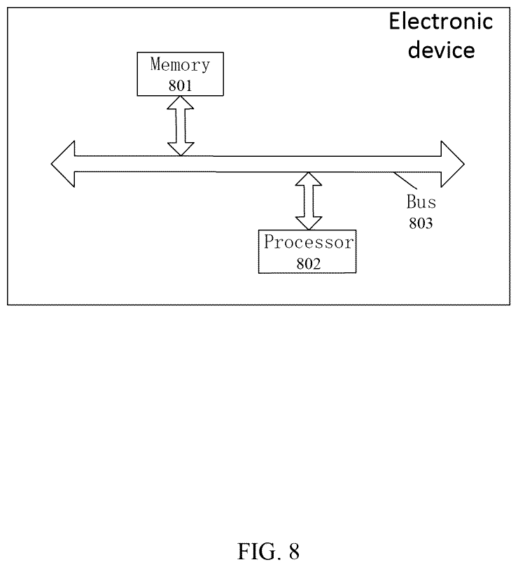

FIG. 8 illustrates an electronic device according to an embodiment of this application. This electronic device can implement the haptic feedback method based on image texture described in the previous embodiments.

As shown in FIG. 8, the electronic device includes: a memory (801), a processor (802), and a bus (803). The memory (801) and the processor (802) are connected via the bus (803). The memory (801) stores a computer program that can run on the processor (802). The processor (802), when executing the computer program, implements the haptic feedback method based on image texture described in the aforementioned embodiments. The number of processors can be one or more.

The memory 801 may be a high-speed random-access memory (RAM) or a non-volatile memory, e.g., a disk memory. The memory 801 stores executable program code, and the processor 802 is coupled with the memory 801.

Furthermore, the embodiment of this application also provides a computer-readable storage medium, which may be located in the electronic device in the above embodiments. This computer-readable storage medium may be the memory in the embodiment shown in FIG. 8.

The computer-readable storage medium stores a computer program, which, when executed by the processor, implements the haptic feedback method described in the previous embodiments. Furthermore, the computer-readable storage medium may also be a USB flash drive, an external hard drive, a read-only memory (ROM), a RAM, a floppy disk, an optical disk, or other medium capable of storing program code.

In the various embodiments provided in this application, it should be understood that the disclosed apparatus and method can be implemented in other ways. For example, the apparatus embodiments described above are merely illustrative, and the division of modules is merely logical functional partition. In actual implementation, there can be alternative ways of division, such as multiple modules or components being combined or integrated into another system, or some features being omitted or not executed. Additionally, the coupling or direct coupling or communication connection between the components or modules shown or discussed can be achieved through interfaces, devices, or indirect coupling or indirect communication connections, which can be electrical, mechanical, or in other forms.

The modules described as separate components may or may not be physically distinct. The components shown as modules may or may not be physical modules, i.e., may be located in one place or distributed across multiple network modules. Depending on the actual needs, some or all of the modules may be selected to achieve the objectives of the embodiment in this application.

In addition, the functional modules in the various embodiments of this application can be integrated into a single processing module, or may exist as separate physical modules. It is also possible for two or more modules to be integrated into a single module. The integrated modules can be implemented either in hardware form or as software functional modules.

If the integrated modules are implemented as software functional modules and are sold or used as standalone products, they can be stored on a computer-readable storage medium. Based on this understanding, the technical solution of this application, or the part that contributes to the existing technology, can be embodied in the form of a software product. This computer software product is stored on a readable storage medium and includes several instructions to make a computer device (e.g., a personal computer, a server, or a network device, etc.) execute all or part of the steps of the method in the various embodiments of this application. The aforementioned readable storage medium includes: USB flash drives, external hard drives, ROM, RAM, floppy disks, optical disks, and other various media capable of storing program code.

It should be noted that, the aforementioned method embodiments are presented as a series of action combinations in order to simplify the description. However, those skilled in the art should be aware that the present application is not limited by the described order of actions, as certain steps can be performed in a different sequence or simultaneously. Additionally, those skilled in the art should also recognize that the embodiments described in the specification are all preferred embodiments, and the actions and modules involved are not necessarily required for the implementation of this application.

In the above embodiments, each embodiment is described with a focus on specific aspects. Parts that are not detailed in one embodiment can be referred to in the relevant descriptions of other embodiments.

The above describes the haptic feedback method and apparatus based on image texture, the device and the storage medium in this application. Those skilled in the art, based on the ideas of the embodiments in this application, will make changes in the specific implementations and application scope. Therefore, the content of this specification should not be understood as a limitation on this application.

What is claimed is:

1. A haptic feedback method based on image texture, comprising:
acquiring object feature information of an image object according to a texture feature parameter of an image texture in a target display image;
acquiring, according to the object feature information, a global relative vibration parameter corresponding to the image object;
on detecting a touch operation event relative to the image object, acquiring, according to the global relative vibration parameter, a local relative vibration parameter corresponding to a position at which a touch operation occurs;
mapping an actual vibration parameter of a haptic feedback actuator based on the local relative vibration parameter, and generating, according to the actual vibration parameter, a vibration control signal corresponding to the position at which the touch operation occurs; and
sending the vibration control signal to the haptic feedback executor to control the haptic feedback executor to perform a corresponding vibration operation on the position at which the touch operation occurs.

2. The haptic feedback method according to claim 1, wherein the acquiring, according to the object feature information, a global relative vibration parameter corresponding to the image object comprises:
acquiring, according to roughness of the image object, a global relative vibration intensity corresponding to the image object, and/or acquiring, according to hardness of the image object, a global relative vibration frequency corresponding to the image object.

3. The haptic feedback method according to claim 2, wherein the object feature information is the roughness, and the acquiring object feature information of an image object according to a texture feature parameter of an image texture in a target display image comprises:
converting the target display image into a grayscale image;
extracting a first texture feature parameter of the grayscale image based on a grayscale symbiotic matrix, wherein the first texture feature parameter comprises at least one of: texture entropy, texture inertia moment, texture contrast, texture correlation, or texture uniformity; and
calculating the roughness of the image object based on a preset function between the first texture feature parameter and the roughness.

4. The haptic feedback method according to claim 2, wherein the object feature information is the hardness, and the acquiring object feature information of an image object according to a texture feature parameter of an image texture in a target display image comprises:
acquiring N displayed images in a video being currently displayed that are previous to the target display image, wherein N is a positive integer greater than 0;
counting second texture feature information of the image texture in the target display image according to the target display image and the N displayed images, wherein the second texture feature information comprises deformation information; and
calculating the hardness of the image object based on a preset function between the second texture feature parameter and the hardness.

5. The haptic feedback method according to claim 4, further comprising:
querying a preset object prior information base for hardness corresponding to the image object, wherein the N displayed images in the video being currently displayed that are previous to the target display image are acquired on failure of the query.

6. The haptic feedback method according to claim 1, wherein the relative vibration parameter comprises a relative vibration intensity and a relative vibration frequency, and the mapping an actual vibration parameter of a haptic feedback actuator based on the local relative vibration parameter comprises:
weighting the local relative vibration intensity based on touch operation pressure and weighting the local relative vibration frequency based on a touch operation speed; and
mapping the weighted local relative vibration intensity to an actual vibration intensity of the haptic feedback actuator, and mapping the weighted local relative vibration frequency to an actual vibration frequency of the haptic feedback actuator.

7. The haptic feedback method according to claim 6, wherein the mapping the weighted local relative vibration intensity to an actual vibration intensity of the haptic feedback actuator and mapping the weighted local relative vibration frequency to an actual vibration frequency of the haptic feedback actuator comprises:
acquiring a rated voltage and a rated frequency response range of the haptic feedback actuator; and
mapping the weighted local relative vibration intensity to the actual vibration intensity of the haptic feedback actuator based on the rated voltage, and mapping the weighted local relative vibration frequency to the actual vibration frequency of the haptic feedback actuator based on the rated frequency response range.

8. An electronic device, comprising a memory and a processor, wherein
the processor is configured to execute a computer program stored in the memory to implement steps in the haptic feedback method based on image texture according to claim 1.

9. A computer readable storage medium, on which a computer program is stored, wherein the computer program is executable by a processor to implement steps in the haptic feedback method based on image texture according to claim 1.
